(19) United States
(12) Patent Application Publication
(10) Pub. No.: US 2012/0249598 A1
(43) Pub. Date: Oct. 4, 2012

(54) DISPLAY CONTROL APPARATUS AND CONTROL METHOD THEREOF

(75) Inventor: Yuki Fukushima, Yokohama-shi (JP)

(73) Assignee: CANON KABUSHIKI KAISHA, Tokyo (JP)

(21) Appl. No.: 13/430,498

(22) Filed: Mar. 26, 2012

(30) Foreign Application Priority Data
Mar. 28, 2011 (JP) 2011-070369

(51) Int. Cl. G09G 5/00

(52) U.S. Cl. 345/660

(57) ABSTRACT

A display control apparatus can quickly switch a state displaying an image without enlargement and a state displaying an image in enlargement display in the least amount of operation effort. When the display control apparatus receives an instruction to start an enlargement mode in a state displaying an image by single display in which an entirety of one image is displayed in the display area of a display unit, the display control apparatus performs control to display a part of the enlarged image in a display area. When the display control apparatus receives an instruction to start the enlargement mode in a state displaying an image by multi display where a plurality of images are displayed in the display area, the display control apparatus displays a part of the image more enlarged than a case of the single display in the display area without going through the single display.

### BACKGROUND OF THE INVENTION

1. Field of the Invention

The present invention relates to a display control apparatus, especially, a display control apparatus capable of enlarging an image to display the image, and a control method thereof.

2. Description of the Related Art

Conventionally, a technology enlarging an image displayed in a display control apparatus has been discussed.

Japanese Patent Application Laid-Open No. 2004-260715 discusses a technology in which when an apparatus enlarges and display an image according to a user's operation and switches the display to another image in a state of enlarging the image, the apparatus enlarges and displays the another image with the same enlargement magnification and the same enlargement position as the image enlarged before switching.

Japanese Patent Application Laid-Open No. 2005-223764 discusses a technology in which when an apparatus enlarges and displays an image, a user can reduce the image by operating a zoom lever to a telephoto side. When the apparatus displays an image at the same magnification, the user can switch the image to a multi-image reproduction by operating the zoom lever to the telephoto side.

Japanese Patent Application Laid-Open No. 2011-028679 discusses a technology in which an image is displayed on a touch panel and enlarged, causing a position of a coordinate touched on the touch panel to be a center of the enlargement, according to an operation of an operation member while the touch panel is touched.

However, in the aforementioned techniques, for enlarging an image from a not enlarged state to an enlargement magnification desired by a user, as an operation to adjust enlargement magnification from a time of starting an enlargement, a plurality of operations or an operation such as a long pressing are necessary, so that time-consuming operation is required. Therefore, even when an enlargement magnification often used by users is defined, a user needs to operate to adjust the enlargement magnification in every enlargement operation, so the user cannot quickly enlarge the image to the enlargement magnification that is used many times. Further, in Japanese Patent Application Laid-Open No. 2005-223764, when a user enlarges an image from the state in which the apparatus performs a multi-image reproduction, it is necessary to once pass through the same size display of a one-sheet image. Thus, the apparatus cannot quickly perform an enlargement display of an image from the state in which the apparatus has performed the multi-image reproduction. Further, after ending of confirmation on the enlargement display, the apparatus cannot quickly return to the before state in which the apparatus performs the multi-image reproduction.

### SUMMARY OF THE INVENTION

The present invention is directed to providing a display control apparatus capable of quickly switching between a state displaying an image without enlargement and a state displaying an image with enlargement display, in the least amount of operation effort.

According to an aspect of the present invention, there is provided a display control apparatus includes a display control unit, a receiving unit, and a control unit. The display control unit is configured to perform control to display an image by at least one of a single display mode and a multi display mode. The single display mode displays an entirety of one image in a display area of a display unit. The multi display mode displays a plurality of images on the display area. The receiving unit is configured to receive a start instruction of an enlargement mode. A control unit is configured, in the case that the display control unit receives an instruction to start the enlargement mode in a state of displaying an image by the single display, to perform control to display a part of an enlarged image in the display area. And the control unit is configure, in the case that the display control unit receives an instruction to start the enlargement mode in a state of displaying an image by the multi display, to perform control to display a part of the image enlarged more than a single display of the image without going through display of the image in the single display mode.

Further features and aspects of the present invention will become apparent from the following detailed description of embodiments with reference to the attached drawings.

### BRIEF DESCRIPTION OF THE DRAWINGS

The accompanying drawings, which are incorporated in and constitute a part of the specification, illustrate embodiments, features, and aspects of the invention and, together with the description, serve to explain the principles of the invention.

FIG. 1 is a configuration block diagram illustrating an image pickup apparatus according to a first embodiment of the present invention.

FIGS. 2A and 2B are external view illustrating an image pickup apparatus according to the first embodiment of the present invention.

FIG. 3 illustrates a display example of a registration screen for registering an enlargement magnification and an enlargement area at a time of starting an enlargement mode.

FIG. 4 is a flowchart of reproduction mode processing.

FIG. 5 is a flowchart of enlargement mode transition processing.

FIG. 6 is a flowchart of enlargement image display processing.

FIG. 7 is a flowchart of enlargement magnification adjustment processing.

FIG. 8 is a flowchart of enlargement mode leaving processing.

FIG. 9A illustrates a display example of an image with single display (full-screen display).

FIG. 9B illustrates a display example of images with multi display.

FIG. 9C illustrates a display example of an image with an enlargement mode.

FIGS. 10A and 10B illustrate display examples before and after image advancing with the enlargement mode.

FIGS. 11A and 11B illustrate display examples before and after enlargement magnification adjustment processing with the enlargement mode.

### DESCRIPTION OF THE EMBODIMENTS

Various embodiments, features, and aspects of the invention will be described in detail below with reference to the drawings.

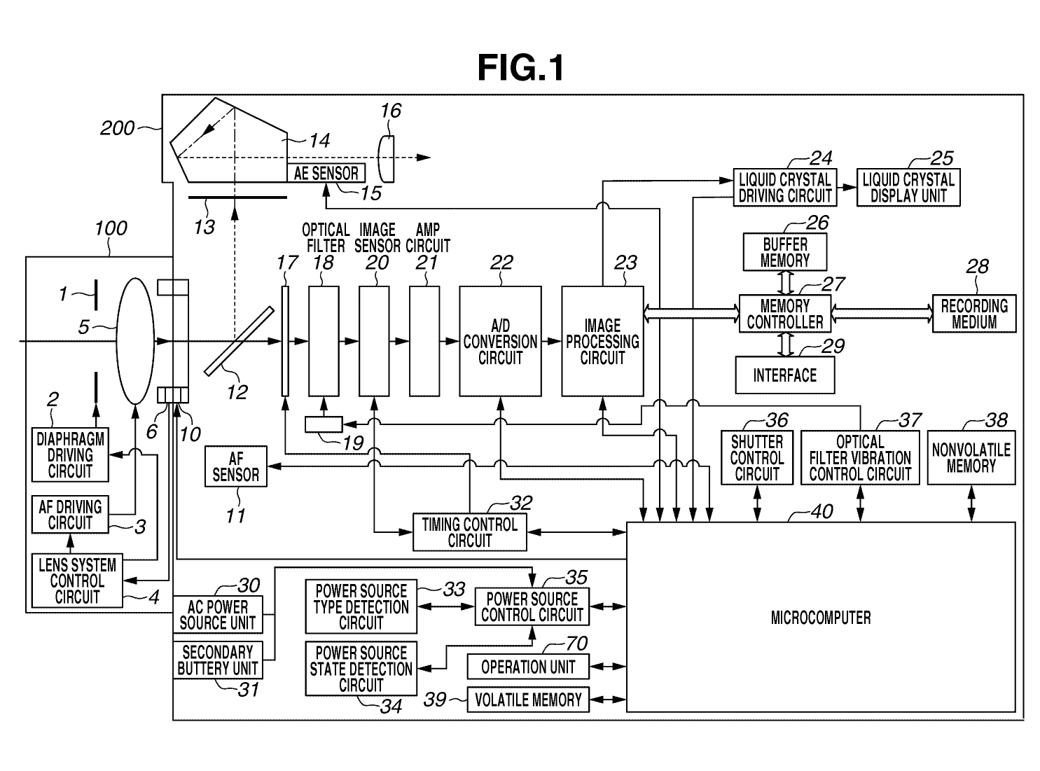

FIG. 1 is a configuration block diagram illustrating an image pickup apparatus 200 according to the first embodiment of the present invention.

A lens unit 100 mounts an interchangeable shooting lens. A lens 5 conventionally consists of a plurality of lenses but, in this case, only one lens is illustrated for simplicity. A communication terminal 6 is used for which the lens 5 communicates to the image pickup apparatus 200 side. A communication terminal 10 is used for which the image pickup apparatus 200 communicates to the lens 5 side. The lens unit 100 communicates to a microcomputer 40 via the communication terminals 6 and 10. Further the lens unit 100 controls a diaphragm 1 by a lens system control circuit 4 inside the lens unit 100 via a diaphragm driving circuit 2. Furthermore, the lens unit 100 focuses by changing a position of the lens 5 via an auto focus (AF) driving circuit 3.

An auto exposure (AE) sensor 15 performs light metering of luminance of an object through the lens unit 100.

An auto focus (AF) sensor 11 outputs defocus amount information to the microcomputer 40. The microcomputer 40 controls the lens unit 100 based on the output information.

A quick return mirror 12 is instructed by the microcomputer 40 at a time of exposure and moved up and down by an actuator not illustrated.

A photographer can confirm focus and composition of an optical image of an object, which are obtained through the lens unit 100, by observing a focusing screen 13 through a pentaprism 14 and finder 16.

A focal-plane shutter 17 can freely control an exposure time of an image sensor 20 by control of the microcomputer 40.

An optical filter 18 generally consists of a low-pass filter and cuts a high frequency component of light entered from the focal-plane shutter 17 to optically guide an object image to the image sensor 20.

The image sensor 20 generally uses a charge coupled device (CCD) or a complementary metal-oxide semiconductor (CMOS), and performs photoelectric conversion of an object image which focused on the image sensor 20 through the lens unit 100 to receive as an electric signal.

An amplifier (AMP) circuit 21 amplifies, with respect to the received electric signal, a photographing signal with a gain corresponding to the set shooting sensitivity.

An analogue/digital (A/D) conversion circuit 22 converts an analog signal, which is converted to the electric signal by the image sensor 20, to a digital signal.

An image processing circuit 23 performs, to the image data converted to the digital signal by the A/D conversion circuit 22, filter processing, color conversion processing, and gamma/knee processing and outputs to a memory controller 27. Further, the image processing circuit 23 also includes a digital/analogue (D/A) conversion circuit. The image processing circuit 23 can also convert image data converted to the digital signal by the A/D conversion circuit 22 and image data input from the memory controller 27 to an analog signal, and output to the liquid display unit 25 via a liquid driving circuit 24. These image processing and display processing by the image processing circuit 23 are switched by the microcomputer 40. Further, the microcomputer 40 performs white balance adjustment based on color balance information of a captured image.

A liquid crystal display unit 25 is a back monitor for displaying an image. Another type of display, such as an organic electro luminescence (EL), can be used, not limited to the liquid crystal display, if the display can display an image.

The memory controller 27 stores raw image data input from the image processing circuit 23 to a buffer memory 26, or image-processed image data to a recording medium 28. Further, reversely, the memory controller 27 retrieves image data from the buffer memory 26 and the recording medium 28 and outputs to the image processing circuit 23. Furthermore, the memory controller 27 can store image data transmitted via the external interface 29 in the recording medium 28 or reversely, output image data stored in the recording medium 28 to an external side via the external interface 29.

As for the external interface 29, universal serial bus (USB), Institute of Electrical and Electronic Engineer (IEEE), and high-definition multimedia interface (HDMI) are examples. The recording medium 28 is a detachable recording medium such as a memory card. However, the recording medium can be a built-in memory. The microcomputer 40 controls timing of the image sensor 20 via a timing control circuit 32.

The power source control circuit 35 is supplied from AC power unit 30 or a secondary battery unit 31 and controls a power source. The power source control circuit 35 receives instruction from the microcomputer 40 and performs ON/OFF of the power source. The power source control circuit 35 also notifies the microcomputer 40 of information of a state of current power source detected by a power state detection unit 34 and current information of power type detected by a power source type detection circuit 33.

The microcomputer 40 controls the focal-plane shutter 17 via a shutter control circuit 36.

An optical filter vibration control circuit 37 vibrates a piezoelectric element 19 connected to an optical filter 18. The optical filter vibration control circuit 37 vibrates the piezoelectric element 19 so as to have predetermined values of a vibration amplitude, a vibration time, and an axial direction of a vibration, according to an instruction of the microcomputer 40.

A nonvolatile memory 38 is a nonvolatile recording medium and can store set values arbitrarily set by a user, such as shutter speed, a diaphragm value, and shooting sensibility, and other various kinds of data, even when the image pickup apparatus is not in a state of power ON.

A volatile memory 39 stores data desired to be temporarily stored, such as, an internal state of the image pickup apparatus and information of the detachable recording medium 28.

An operation unit 70 is a member for various operations as an input unit receiving operations from a user. The operation unit 70 includes at least following operation units. That is, a release button 201, a main electronic dial 202, a sub electronic dial 203, a power source switch 204, a protect button 205, a menu button 206, a dilation button 207, an enlargement mode button 208, a reproduction instruction button 209, a single/multi switching button 210, and a multi controller 211.

The microcomputer 40 controls each unit included in the image pickup apparatus 200. The microcomputer 40 develops and executes the program recorded in the nonvolatile memory 38, using the volatile memory 39 as a work memory, and executes various processing described below.

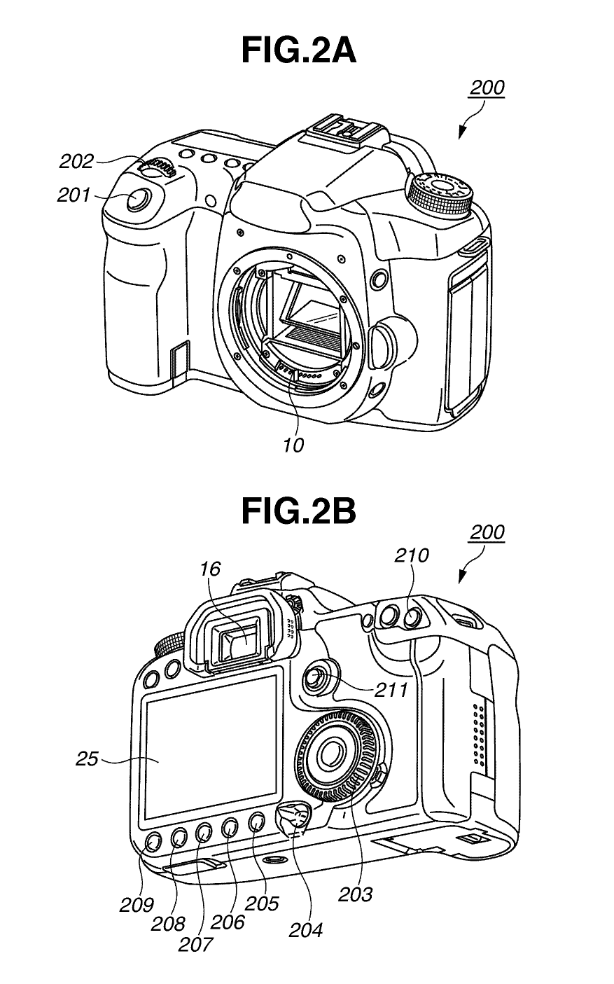

FIG. 2A illustrates an appearance configuration of the entirety of the image pickup apparatus 200 from the front.

FIG. 2B illustrates an appearance configuration of the entirety of the image pickup apparatus 200 from the back. The same numerals are used for portions common to FIG. 1.

The release button 201 instructs shooting preparation and shooting and performs measurement of luminance of an object and focus adjustment by half-pressing. Further, by full-pressing, the shutter is released and image shooting is performed.

The main electronic dial 202 is a rotary operation member. A user performs setting the set values of shutter speed and diaphragm, and fine-adjustment of an enlargement magnification in the enlargement mode by rotating the main electronic dial 202.

The sub electronic dial 203 is a rotary operation member. A user performs setting the set values of diaphragm and exposure compensation and a one-sheet feeding operation of an image in a state of displaying an image by rotating the sub electronic dial 203.

The power source switch 204 is an operation member for performing ON/OFF of the power source.

The protect button 205 performs processing, such as protecting and rating, to the images stored in internal and external recording mediums of the image pickup apparatus 200.

The menu button 206 displays various setting screens in the liquid crystal display unit 25.

The deletion button 207 instructs deletion of images stored in internal and external recording mediums of the image pickup apparatus 200.

The enlargement mode button 208 receives, in a reproduction state, operations of a transition instruction to the enlargement mode (start instruction of the enlargement mode) and a leaving instruction from the enlargement mode (ending instruction of the enlargement mode).

The reproduction instruction button 209 displays an image stored in internal and external recording mediums of the image pickup apparatus 200 in the liquid crystal display unit 25.

The single/multi switching button 210 instructs to lock luminance of a measured object or, in a reproduction state to switch display state in the single display or the multi-display.

The multi controller 211 is an operation member operable in a plurality of directions for setting a focusing point which is a start point of auto focus, moving an enlargement range (enlarging area).

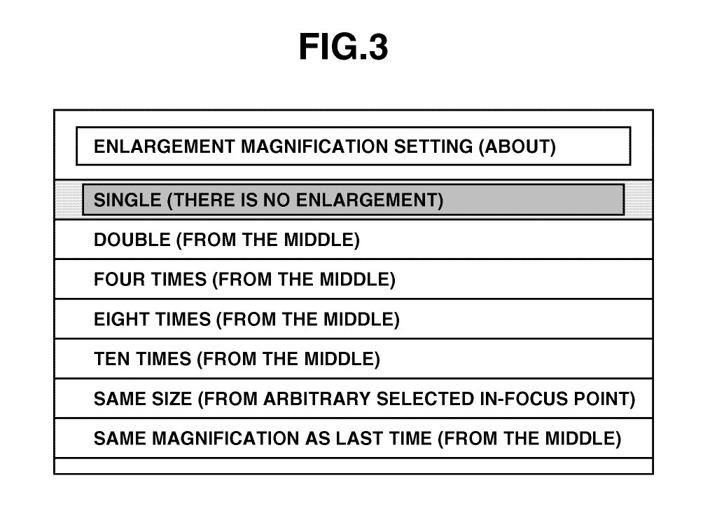

FIG. 3 illustrates a display example of a registration screen which registers the enlargement magnification and the enlargement area of an image at a time of starting the enlargement mode. The registration screen in FIG. 3 is displayed by pressing the menu button 206 included in the operation unit 70 to display a menu screen in the liquid crystal display unit 25, and selecting a menu item, which performs setting at a time of the enlargement mode, in menu items relating to reproduction. As illustrated in FIG. 3, the following options are displayed as the enlargement magnification and the enlargement area at a time of starting the enlargement mode.

Single (there is no enlargement): an enlargement magnification displaying an image with a maximum size in which an entirety of an image of one sheet can be settled in a display area in the liquid crystal display unit 25 (i.e., full-screen display).

Double (from the middle): an enlargement magnification is double the full-screen display. An enlargement area in which a center of the enlargement area becomes the middle of an image is registered.

Four times (from the middle)

Eight times (from the middle)

Ten times (from the middle)

Same size (from an arbitrary selected in-focus point): an enlargement magnification in which one pixel of recording pixels of image data is displayed by using one pixel of the liquid crystal display unit 25, i.e., a pixel direct. An enlargement area, in which a center of an enlargement area becomes an in-focused position (an in-focus point) in the image at a time of imaging, is registered.

Same magnification as last time (from the middle): a condition, in which an enlargement magnification is the magnification when a display state is left (ended) from the enlargement mode at a last time (that is, the enlargement magnification is changeable each time), is registered. An enlargement area, in which a center of the enlargement area becomes the middle of an image, is registered.

A user moves a selection frame to the arbitrary option by operation of sub electronic dial 203 and presses the setting button, so that the user can register the desired enlargement magnification and enlargement area. The registered enlargement magnification and enlargement area are recorded in the nonvolatile memory 38. In addition, the aforementioned registration method is not limiting, and the enlargement magnification and the enlargement area can be registered independently of each other. In other words, an arbitrary combination can be registered. Further, only any one of the enlargement magnification and the enlargement area (enlargement position) can be registered by a user.

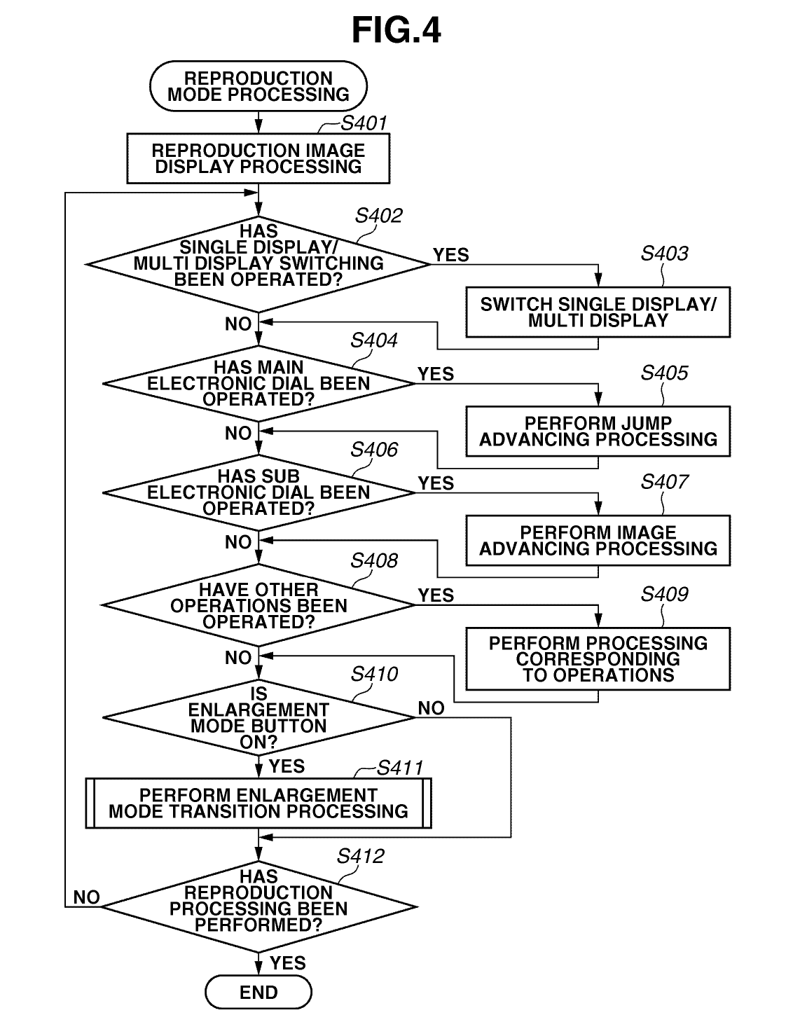

FIG. 4 illustrates a flowchart of the reproduction mode processing executed by the image pickup apparatus 200. In this processing, the microcomputer 40 develops and executes the program recorded in the volatile memory 39, using the volatile memory 39 as a work memory, so that the processing can be realized. In addition, in processing the reproduction processing, the nonvolatile memory 38 stores an enlargement mode flag indicating whether the display state is in the enlargement mode as follows. (The enlargement mode flag=1: indicates currently in the enlargement mode, the enlargement mode flag=0: indicates currently not in the enlargement mode). When the reproduction mode processing is started, at first, the enlargement mode flag is initialized to be 0. In a condition in which the power source of the image pickup apparatus 200 is ON, when the reproduction instruction button 209 is pressed, the reproduction mode processing is started.

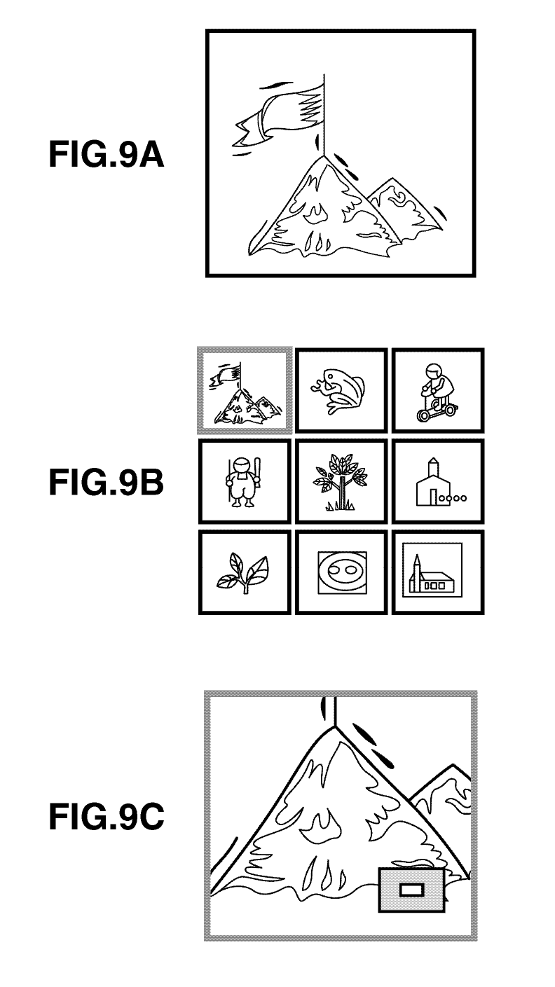

In step S401, the microcomputer 40 drives the image processing circuit 23, processes images received from the buffer memory 26 and the recording medium 28 via the memory controller 27, and outputs the processed images to the liquid crystal display unit 25 via the liquid crystal driving circuit 24 to display. The images are displayed by any one of the single display and the multi display. In the single display, entirety of an image in one sheet is displayed in the liquid crystal display unit 25 (full-screen display) as illustrated in FIG. 9A. In the multi display, a plurality of images is simultaneously displayed in one screen as illustrated in FIG. 9B.

In step S402, the microcomputer 40 determines whether the single/multi switching button 210 is operated. When the microcomputer 40 determines that the single/multi switching button 210 is operated (YES in step S402), the processing proceeds to S403. When the microcomputer 40 determines that the single/multi switching button 210 is not operated (NO in step S402), the processing proceeds to S404.

In step S403, the microcomputer 40 switches the display state to the single display (entirety screen display) or to the multi display according to the operation of the single display/multi display switching button 210. For example, according to pressing the single/multi switching button 210, when the image pickup apparatus 200 has performed the single display (full-screen display) before the determination in step S402, the apparatus 200 performs the multi display. When the image pickup apparatus 200 has performed the multi display before the determination in step S402, the apparatus 200 switches the display state to the single display. Further, the microcomputer 40 records the information of the current display state whether the current display state is in the single display or in the multi display, which is the result of switching, in the volatile memory 39.

In step S404, the microcomputer 40 determines whether the main electronic dial 202 has been operated. When the microcomputer 40 determines that the main electronic dial 202 has been operated (YES in step S404), the processing proceeds to step S405. When the microcomputer 40 determines that the main electronic dial 202 has not been operated (NO in step S404), the processing proceeds to step S406.

In step S405, the microcomputer 40 performs jump advancing processing. The jump advancing processing displays an image beyond by jump sheet numbers the current image, according to a rotation operation by one click of the main dial 202. The jump sheet numbers are predetermined by an order of rows of images to have image advancing performed (for example, an order of file numbers). In the jump advancing processing, the images between the current image and the image beyond the current image by jump sheet numbers are omitted and not displayed. In the following descriptions, the current image in the single display is an image currently displayed in the liquid crystal display unit 25. The current image in the multi display is a currently selected image by a selection frame in a plurality of images displayed in the liquid crystal display unit 25.

The jump sheet numbers are set beforehand by a user selecting a number of sheets, for example, 10 sheets or 100 sheets. For example, a case in which images of continuous 50 sheets are recorded in the recording medium 28 and the jump sheet numbers are set to be 10 sheets, will be considered. The 50 sheets are continuous files of number 0001 to number 0050. In this case, when a user rotates clockwise the main electronic dial 202 by one click in the state that the file number of the current image is 0031, the image with file number 0041 is displayed. To the contrary, when a user rotates counterclockwise the main electronic dial 202 by one click, the image with file number 0021 is displayed.

In step S406, the microcomputer 40 determines whether the sub electronic dial 203 has been operated. When the microcomputer 40 determines that the sub electronic dial 203 has been operated (YES in step S406), the processing proceeds to step S407. When the microcomputer 40 determines that the sub electronic dial 203 has not been operated (NO in step S406), the processing proceeds to step S408.

In step S407, the microcomputer 40 performs image advancing processing according to a rotation direction of the sub electronic dial 203, performed in step S406. More specifically, when the sub electronic dial 203 is rotated counterclockwise by one click, the microcomputer 40 reads an image which is one sheet before the current image in image advancing order (for example, order of file numbers) from the recording medium 28 via the memory controller 27 and displays in the liquid crystal display unit 25. When the sub electronic dial 203 is rotated clockwise by one click, the microcomputer 40 reads an image which is one sheet after the current image in image advancing order from the recording medium 28 via the memory controller 27 and displays in the liquid crystal display unit 25.

In step S408, the microcomputer 40 determines whether the other operations to the image, for example, the operation of the delete button 207 and the operation of the protect button 205 have been operated. When the microcomputer 40 determines that the other operations have been performed (YES in step S408), the processing proceeds to step S409. When the microcomputer 40 determines that the other operations have not been performed (NO in step S408), the processing proceeds to step S410.

In step S409, the microcomputer 40 performs processing according to the other operations. For example, when the delete button 207 has been pressed, the microcomputer 40 performs processing to delete the current display from the recording medium 28. When the protect button 205 has been pressed, the microcomputer 40 performs, to the current image, processing to add or delete attribute information, such as, protecting or rating.

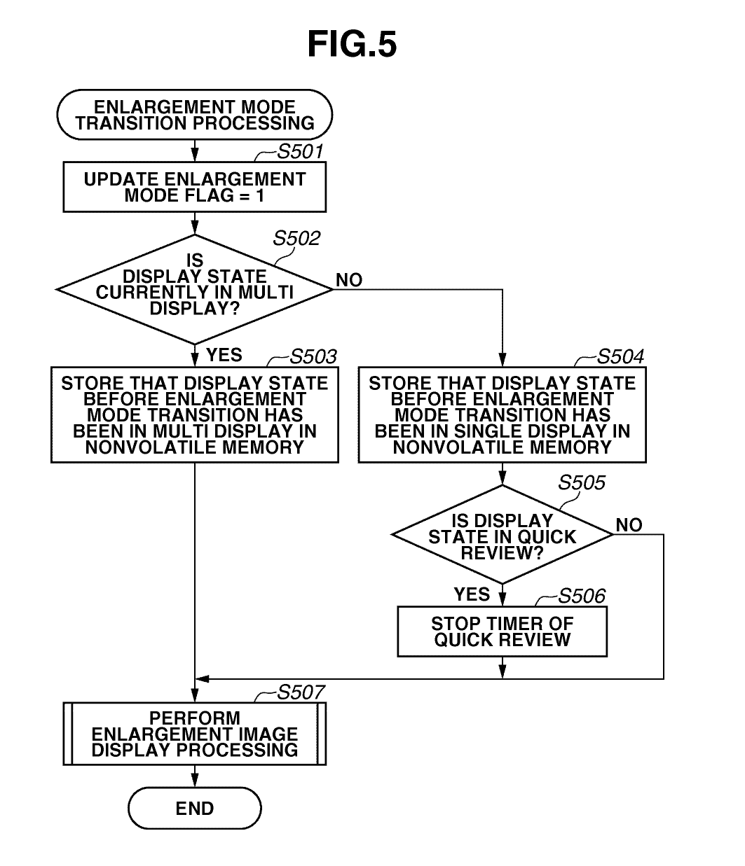

In step S410, the microcomputer 40 determines whether the enlargement mode button 208 is pressed. When the microcomputer 40 determines that the enlargement button 208 is pressed (YES in step S410), the processing proceeds to step S411 and performs the enlargement mode transition processing. When the microcomputer 40 determines that the enlargement button 208 is not pressed (NO in step S410), the processing proceeds to step S412. The enlargement mode transition processing will be described later, referring to FIG. 5.

In step S412, the microcomputer 40 determines whether the ending operation of the reproduction mode is performed. The ending operation of the reproduction mode is, for example, the power source becomes OFF by the power source switch 204 or the release button 201 being pressed. When the microcomputer 40 determines that the ending operation is not performed (NO in step S412), the processing returns step S402 and the processing is repeated. When the microcomputer 40 determines that the ending operation is performed (YES in step S412), the reproduction processing is ended.

FIG. 5 illustrates a flowchart of the enlargement mode transition processing aforementioned in step S411 in FIG. 4. In this processing, the microcomputer 40 develops and executes the program recorded in the nonvolatile memory 38, using the volatile memory 39 as a work memory, so that the processing can be realized.

In step S501, the microcomputer 40 updates the enlargement flag, which is stored in volatile memory 39, to be 1.

In step S502, the microcomputer 40 determines whether the display state is in the multi display, based on information recorded in the volatile memory 39, whether the display state is in the single display or in the multi display. When the microcomputer 40 determines that the display state is in the multi display (YES in step S502), the processing proceeds to step S503. When the microcomputer 40 determines that the display state is not in the multi display (NO in step S502), the processing proceeds to step S504.

In step S503, the microcomputer 40 stores information that the display state is in the multi display, in data which is stored in the nonvolatile memory 38 and indicates what the display state before the enlargement mode transition (display state information before enlargement mode transition) is.

In step S504, the microcomputer 40 stores information that the display state is in the single display (full-screen display), in data which is stored in the nonvolatile memory 38 and indicates what the display state before the enlargement mode transition (display state information before enlargement mode transition) is.

In step S505, the microcomputer 40 determines whether the display state is in certification screen display (quick review) immediately after shooting. When the microcomputer 40 determines that the display state is in the quick review (YES in step S505), the processing proceeds to S506. When the microcomputer 40 determines that the display state is not in the quick review (NO in step S505), the processing proceeds to S507.

In step S506, the microcomputer 40 stops a timer counting a display time when the display state has been in the quick review display. The timer counts the time until the automatic ending of the quick review display.

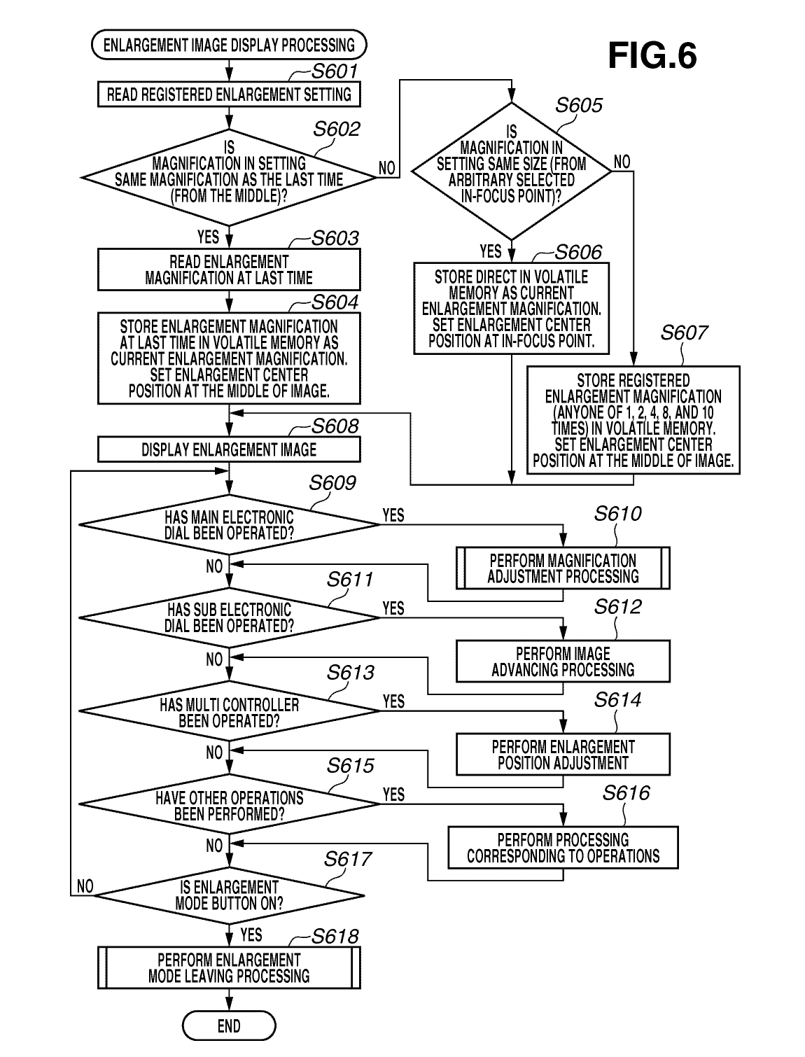

In step S507, the microcomputer 40 performs the enlargement image display processing. The detail of the enlargement image display processing will be described below, referring to FIG. 6.

FIG. 6 illustrates a flowchart of the enlargement image display processing in step S507 in FIG. 5. In this processing, the microcomputer 40 develops and executes the program recorded in the nonvolatile memory 38, using the volatile memory 39 as a work memory, so that the processing can be realized.

In step S601, the microcomputer 40 reads, from the nonvolatile memory 38, the enlargement magnification and the enlargement area (registered enlargement setting) when the enlargement mode is started, in which the registered enlargement setting is registered beforehand by a user, using the aforementioned registration screen in FIG. 3.

In step S602, the microcomputer 40 determines whether the registered enlargement setting read in step S601 is “the same magnification as the last time (from the middle)”. When the microcomputer 40 determines that the registered enlargement setting is “the same magnification as the last time (from the middle)” (YES in step S602), the processing proceeds to step S603. When the microcomputer 40 determines that the registered enlargement setting is not “the same magnification as the last time (from the middle)” (NO in step S602), the processing proceeds to step S605.

In step S603, the microcomputer 40 reads the enlargement magnification when the enlargement mode is ended at the last time (the enlargement magnification at the last time). The enlargement magnification is stored in the nonvolatile memory 38. In step S604, the microcomputer 40 stores the read enlargement magnification at the last time in the volatile memory 39. Further, the microcomputer 40 sets an enlargement center position at the middle of an image.

In step S605, the microcomputer 40 determines whether the registered enlargement setting read in step S601 is “same size (from an arbitrary in-focus point)”. When the microcomputer 40 determines that the registered enlargement setting is “same size (from an arbitrary in-focus point)” (YES in step S605), the processing proceeds to step S606. When the microcomputer 40 determines that the registered enlargement setting is not “same size (from an arbitrary in-focus point)” (NO in step S605), the processing proceeds to step S607.

In step S606, the microcomputer 40 stores pixel direct, which is an enlargement magnification, in the volatile memory 39. Further, the microcomputer 40 sets an enlargement center position at the in-focus point of the image.

In step S607, the microcomputer 40 stores the enlargement magnification read in S601 of the registered enlargement setting in the volatile memory 39. The enlargement magnification is any one of one time, two times, four times, eight times, and ten times. Further, the microcomputer 40 sets an enlargement center position at the middle of the image.

In step S608, the microcomputer 40 performs enlargement processing of the current image via the image processing circuit 23 according to the enlargement magnification stored in the volatile memory 39 in steps S604, S606, and S607 and outputs to the liquid crystal display unit 25 via the liquid crystal display driving circuit 24 to display. In FIG. 9C, a display example of an enlargement display of an image when the enlargement mode is started is illustrated.

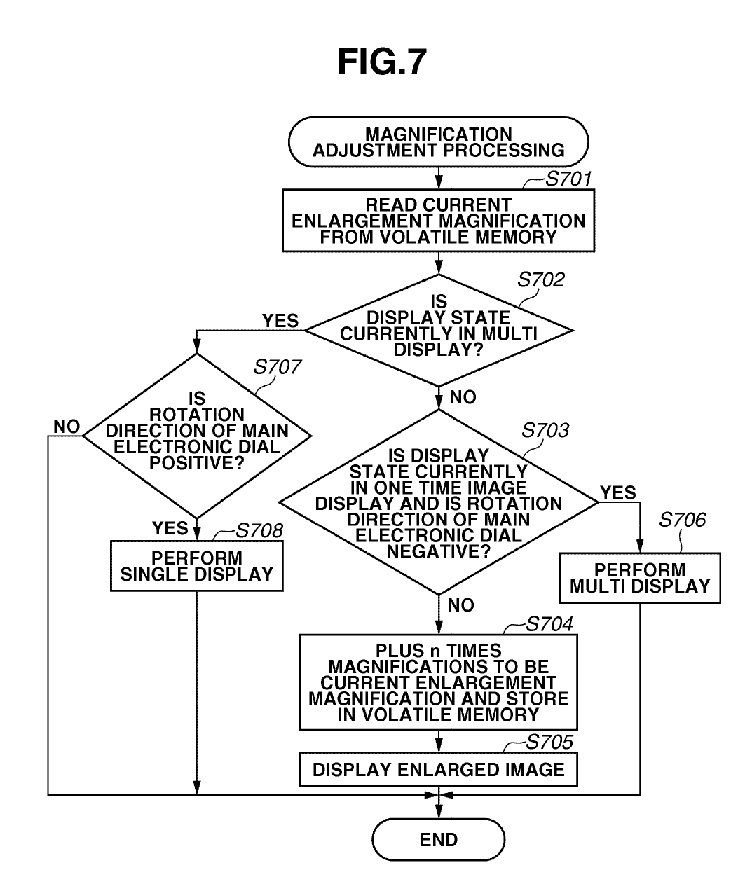

In step S609, the microcomputer 40 determines whether the main electronic dial 202 has been operated. When the microcomputer 40 determines that the main electronic dial 202 has been operated (YES in step S609), the processing proceeds to step S610 and the microcomputer 40 performs the magnification adjustment processing. When the microcomputer 40 determines that the main electronic dial 202 has not been operated (NO in step S609), the processing proceeds to step S611. The magnification adjustment processing will be described later, referring to FIG. 7.

In step S611, the microcomputer 40 determines whether the sub electronic dial 203 has been operated. When the microcomputer 40 determines that the sub electronic dial 203 has been operated (YES in step S611), the processing proceeds to S612. When the microcomputer 40 determines that the sub electronic dial 203 has not been operated (NO in step S611), the processing proceeds to S613.

In step S612, the microcomputer 40 performs the image advancing processing in the enlargement mode (image advancing with enlargement) corresponding to the rotation direction of the operation of sub electronic dial 203 performed in step S611. More specifically, when the sub electronic dial 203 is rotated counterclockwise by one click, the microcomputer 40 reads, from the recording medium 28, an image which is one sheet before the current image in order of image advancing (for example, order of a file number) via the memory controller 27. Further, the microcomputer 40 performs enlargement processing of the image, using the image processing circuit 23, and displays in the liquid crystal display unit 25. The enlargement processing is performed based on the same enlargement magnification and enlargement area of the image displayed before the operation of the sub electronic dial 203. When the sub electronic dial 203 is rotated clockwise by one click, the microcomputer 40 displays the image, which is one sheet after the current image in the order of image advancing, with similar enlargement.

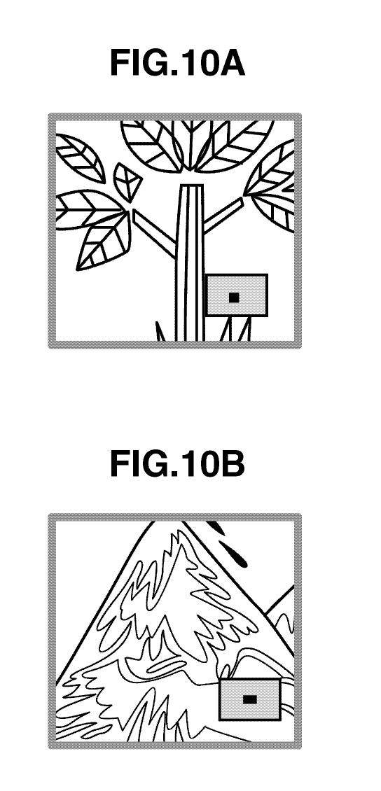

FIGS. 10A and 10B illustrate display examples in the liquid crystal display unit 25, which are before and after of the image advancing in the enlargement mode. The image is enlarged and displayed before the image advancing is performed as illustrated in FIG. 10A. When the image advancing is performed by operating the sub electronic dial 203, the image of one sheet before or one sheet after is displayed in the enlargement display with the same enlargement magnification and enlargement area as before the image advancing as illustrated in FIG. 10B.

In step S613, the microcomputer 40 determines whether the multi controller 211 has been operated. When the microcomputer 40 determines that the multi controller 211 has not been operated (NO in step S613), the processing proceeds to step S615. When the microcomputer 40 determines that the multi controller 211 has been operated (YES in step S613), the processing proceeds to step S614.

In step S614, according to the operation direction of the multi controller 211 performed in step S613, the microcomputer 40 moves an enlargement position (enlargement area). In this case, the enlargement position can be stored in the nonvolatile memory 38.

In step S615, the microcomputer determines whether other operations to an image are operated. The other operations are, for example, an operation of the delete button 207 and an operation of the protect button 205. When the microcomputer 40 determines that the other operations are operated (YES in step S615), the processing proceeds to step S616. When the microcomputer 40 determines that the other operations are not operated (NO in step S615), the processing proceeds to step S617.

In step S616, the microcomputer 40 performs the processing corresponding to the other operations. For example, when the delete button 207 is pressed, the microcomputer deletes the current image from the recording medium 28. When the protect button 205 is pressed, the microcomputer 40 performs processing for adding or deleting attribute information, such as protecting and rating, to the current image. In this case, the microcomputer 40 keeps the enlargement mode and holds the enlargement magnification and the enlargement position.

In step S617, the microcomputer 40 determines whether the enlargement mode button 208 is pressed. When the microcomputer 40 determines that the enlargement button 208 is pressed (YES in step S617), the processing proceeds to step S618 (receiving of ending instruction of the enlargement mode). When the microcomputer 40 determines that the enlargement button 208 is not pressed (NO in step S617), the processing returns to step S609 and repeats the processing.

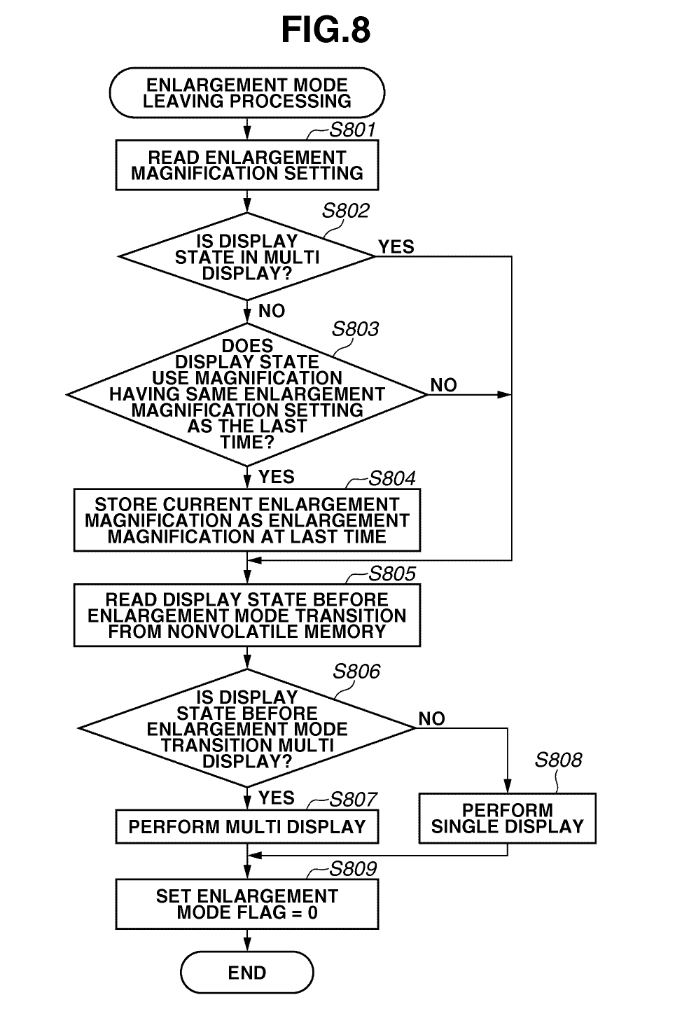

In step S618, the microcomputer 40 performs the enlargement mode leaving processing. The enlargement mode leaving processing will be described later, referring to FIG. 8.

FIG. 7 illustrates a flowchart of the magnification adjustment processing described in step S610 in FIG. 6. In this processing, the microcomputer 40 develops and executes the program recorded in the nonvolatile memory 38, using the volatile memory 39 as a work memory, so that the processing can be realized.

In step S701, the microcomputer 40 reads the current enlargement magnification stored in the volatile memory 39.

In step S702, the microcomputer 40 determines whether the display state is currently in the multi display, based on the information recorded in the volatile memory 39, whether the display state is in the single display or in the multi display. When the microcomputer 40 determines that the display state is in the multi display (YES in step S702), the processing proceeds to step S707. When the microcomputer 40 determines that the display state is not in the multi display (NO in step S702), the processing proceeds to step S703.

In step S703, the microcomputer 40 determines whether a currently displayed image is in the full-screen display (the enlargement magnification is single) and the rotation direction of the main electronic dial 202 is counterclockwise (negative). When the microcomputer 40 determines that the result is true, the processing proceeds to step S706. When the microcomputer 40 determines that the result is false, the processing proceeds to step S704.

In step S704, the microcomputer 40 stores, in the volatile memory 39, a new enlargement magnification in which a magnification (n magnification) is added to the current enlargement magnification read in step S701. The n magnification is determined according to the rotation direction and a rotation amount of the electronic dial 202. When the rotation direction is clockwise (positive), the new enlargement magnification becomes the enlargement magnification enlarging more. When the rotation direction is counterclockwise (negative), the new enlargement magnification becomes the enlargement magnification reducing more.

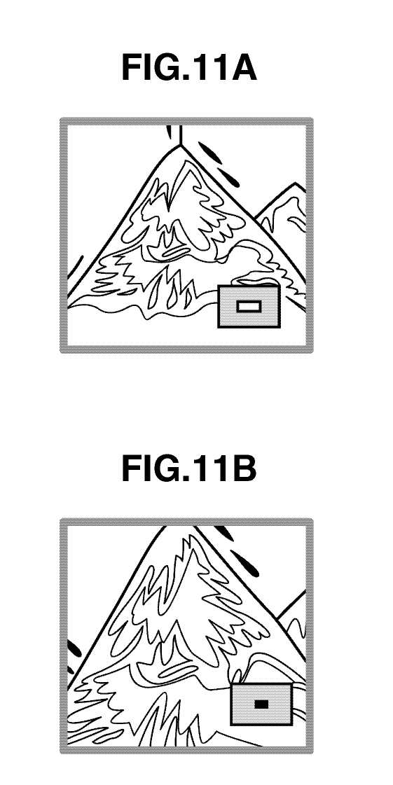

In step S705, the microcomputer 40 performs the enlargement processing of the current image by using the image processing circuit 23, according to the new enlargement magnification stored in the volatile memory 39 in step S704, and outputs to the liquid crystal display unit 25 via the liquid crystal driving circuit 24. FIG. 11A illustrates a display example before performing the enlargement display in step S705. FIG. 11B illustrates an example of the enlargement display in step S705. Thus, the enlargement magnification can be changed (adjusted) from FIG. 11A to FIG. 11B according to an operation of the main electronic dial 202 by a user.

On the other hand, in step S706, the microcomputer 40 switches the display state to the multi display. More specifically, the microcomputer 40 retrieves a plurality of images from the recording medium 28 via the memory controller 27 and outputs to the liquid crystal display unit 25 via the liquid crystal driving circuit 24 to display in one screen. The microcomputer 40 stores information of the current display state (in the multi display), which is a result of switching, in the volatile memory 39. In this case, the enlargement mode flag is not changed and the enlargement mode (the enlargement mode flag=1) has been kept.

On the other hand, in step S707, the microcomputer 40 determines whether the rotation direction of the main electronic dial 202 is clockwise (positive). When the microcomputer determines that the rotation direction of the main electronic dial 202 is clockwise (YES in step S707), the processing proceeds to step S708. When the microcomputer determines that the rotation direction of the main electronic dial 202 is not clockwise (NO in step S707), the magnification adjustment processing is ended.

In step S708, the microcomputer 40 switches the display state to the single display (full-screen display) and stores information of the current display state (in the single display), which is a result of switching, in the volatile memory 39. In this case, the enlargement magnification is single. When the main electronic dial 202 is operated clockwise more after switching to the single display, the image is displayed with a larger magnification.

FIG. 8 illustrates a flowchart of the enlargement mode leaving processing aforementioned in step S618 in FIG. 6. In this processing, the microcomputer 40 develops and executes the program recorded in the nonvolatile memory 38, using the volatile memory 39 as a work memory, so that the processing can be realized.

In step S801, using the registration screen in FIG. 3, the microcomputer 40 reads, from the nonvolatile memory 38, the enlargement magnification and the enlargement area at a time of starting the enlargement mode (the registered enlargement setting), which are registered beforehand.

In step S802, the microcomputer 40 determines whether the display state is currently in the multi display, based on the information stored in the volatile memory 39, whether the display state is in the single display or the multi display. When the microcomputer determines that the display state is not currently in the multi display (NO in step S802), the processing proceeds to step S803. When the microcomputer determines that the display state is currently in multi display (YES in step S802), the processing proceeds to step S805.

In step S803, the microcomputer 40 determines whether the registered enlargement setting read in step S801 is “the same magnification as the last time (from the middle)”. When the microcomputer 40 determines that the registered enlargement setting is “the same magnification as the last time (from a center)” (YES in step S803), the processing proceeds to step S804. When the microcomputer 40 determines that the registered enlargement setting is not “the same magnification as the last time (from the middle)” (NO in step S803), the processing proceeds to step S805.

In step S804, the microcomputer 40 stores the current enlargement magnification (the enlargement magnification immediately before ending of the enlargement mode), which is temporarily stored in the volatile memory 39, in the nonvolatile memory 38 as the enlargement magnification at the last time.

In step S805, the microcomputer 40 reads the display state information before the enlargement mode transition which is stored in the nonvolatile memory 38 in step S503 or S504 in FIG. 5.

In step S806, the microcomputer 40 determines whether the display state before the enlargement mode transition was the multi display, based on the display state information before the enlargement mode transition read in step S805. When the microcomputer 40 determines that the display state before the enlargement mode transition was the multi display (YES in step S806), the processing proceeds to step S807. When the microcomputer 40 determines that the display state before the enlargement mode transition was not the multi display (NO in step S806), the processing proceeds to step S808.

In step S807, the microcomputer 40 retrieves a plurality of sheets of images, which includes the image currently displayed in the enlargement display, from the recording medium 28 via the memory controller 27 and performs image processing. Then the microcomputer 40 outputs the processed images to the liquid crystal display unit 25 via the liquid crystal driving circuit 24 to display the images with the multi display. Further, the microcomputer 40 records information of the current display state (in the multi display) in the volatile memory 39. In this case, as illustrated from FIG. 9C to FIG. 9B, the display state transits in the screen from the enlargement image display state to the multi display state.

In step S808, the microcomputer 40 outputs and displays the image currently displayed in the enlargement display to the liquid crystal display unit 25 via the liquid crystal driving circuit 24 so as to display in the full-screen display (the single display). The microcomputer 40 records information of the current display state (in the single display) in the volatile memory 39. At this time, as illustrated from FIG. 9C to FIG. 9A, the display state transits in the screen from the enlargement image display state to the full-screen image display state.

In step S809, the microcomputer 40 sets the enlargement mode flag stored in volatile memory 39 to be 0 (not in the enlargement mode) and ends the enlargement mode leaving processing.

As described above, by only one operation of the enlargement mode button 208, a user can display an image in the enlargement display with a predetermined enlargement magnification registered by the user, even from any states of the full-screen display and the multi display (both states display the entirety of the image). Therefore, a user can enlarge an image with desired enlargement magnification by a procedure involving less operation. Even from the multi display, a user can directly display the currently selected image in enlargement display with a desired enlargement magnification without going through the full-screen display once. Further, after starting the enlargement mode to display the enlargement display, a user can adjust the enlargement magnification and the enlargement position according to the operation by the user. After displaying the image in enlargement display with the enlargement magnification desired by a user, the user can perform processing, such as deletion and addition of protecting attributes and addition of rating attribute. Further, when a user press the enlargement mode button 208 in a state in enlargement display, the image pickup apparatus can release the enlargement and return to the display state displaying before transition to the enlargement display mode (the full-screen display or the multi display). Therefore, a user can smoothly perform continuation of the operation before transition to the enlargement mode without trouble, even after leaving the enlargement mode. For example, when the display state transits from the multi display to the enlargement mode and then leaves the enlargement mode, the display state can return to the multi display without going through the full-screen display. Thus, a user can compare a plurality of images or quickly select another image by seeing the multi display. Thus, according to the present invention, the image pickup apparatus can quickly switch between the state displaying an image without enlargement and the state displaying an image in enlargement display with the enlargement magnification desired by a user.

In addition, in the aforementioned embodiment, as processing capable of subjecting to an image when the apparatus is in the enlargement mode and not in the enlargement mode, the examples of deletion, addition of protecting attributes and addition of rating attribute are described. However, the processing is not limited to those. The processing, such as addition of classification information, digital print order format (DPOF) setting (printing reservation and reproduction reservation), trimming, resizing, retouch processing, registration to play list, and image rotation processing can be added to be performed. The instruction to perform these processing can be received when the apparatus is in the enlargement mode and not in the enlargement mode. Further, the enlargement magnification at a time of starting the enlargement mode is set to be the enlargement magnification and the enlargement position which are set beforehand by a user. However, the setting is not limited to this. The image can be enlarged by an enlargement magnification and an enlargement position of default set beforehand. In this configuration, one feature of the present invention, i.e., the apparatus can directly transit from any states of the single display and the multi display to the enlargement mode and can return to a before state when the apparatus leaves the enlargement mode, can be realized. Further, both the start instruction of the enlargement mode and the ending instruction of the enlargement mode are received by the same operation member (the enlargement mode button 208). However, another operation to another operation member can be used.

In addition, control of the microcomputer 40 can be performed by one hardware. Further, a plurality of hardware can be assigned to these processing and control an entirety of the apparatus.

Further, the present invention is described based on the embodiments but is not limited by these specified embodiments. The present invention can include various embodiments which do not deviate from the scope of the present invention. Furthermore, the aforementioned each embodiment is one embodiment of the present invention, and each embodiment can be properly combined.

Further, in the aforementioned embodiment, an example in which the present invention is applied to the image pickup apparatus is described. However, the present invention is not limited to apply to this case, and can apply to a display control apparatus capable of enlarging and displaying an image. More specifically, the present invention can apply to a personal computer, a personal digital assistant (PDA), a mobile phone, a portable image viewer, a printer device including a display, a digital photo frame, a music player, a game machine, and an electronic book reader.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to embodiments, it is to be understood that the invention is not limited to the disclosed embodiments. It will of course be understood that this invention has been described above by way of example only, and that modifications of detail can be made within the scope of this invention.

This application claims priority from Japanese Patent Application No. 2011-070369 filed Mar. 28, 2011, which is hereby incorporated by reference herein in its entirety.

What is claimed is:

1. A display control apparatus comprising:
a display control unit configured to perform control to display an image by at least one of a single display mode and a multi-display mode, wherein the single display mode displays an entirety of one image in a display area of a display unit, and the multi display mode displays a plurality of images in the display area;
a receiving unit configured to receive an instruction to start an enlargement mode; and
a control unit configured, in the case that the display control unit receives an instruction to start the enlargement mode in a state of displaying an image by the single display, to perform control to display a part of an enlarged image in the display area and configured, in the case that the display control unit receives an instruction to start the enlargement mode in a state of displaying an image by the multi display, to perform control to display a part of the image enlarged more than a single display of the image without going through display of the image in the single display mode.

2. The display control apparatus according to claim 1,
further comprising:
a registration unit configured, based on an operation by a user, to register an enlargement magnification of an image at a time of starting the enlargement mode displayed according to an instruction to start the enlargement mode;
wherein the display control unit is configured to perform control to display a part of the image enlarged with an enlargement magnification registered by the registration unit, in both the cases that the display control unit receives an instruction to start the enlargement mode in a state of displaying an entirety of an image by the single display, and that the display control unit receives an instruction to start the enlargement mode in a state of displaying an image by the multi display.

3. The display control apparatus according to claim 1,
wherein the display control unit is configured, in the case that the display control unit receives an instruction to end the enlargement mode at a time of the enlargement mode displaying a part of the enlarged image in the display area, to perform control to display an image in the single display or the multi display, by which a display is performed before receiving an instruction to start the enlargement mode.

4. The display control apparatus according to claim 3,
wherein the instruction to start the enlargement mode and the instruction to end the enlargement mode are received by the same type of operation to the same operation member.

5. The display control apparatus according to claim 1,
further comprising:
a changing unit configured, after receiving an instruction to start the enlargement mode, and enlarging and displaying an image, to change at least one of an enlargement magnification and an enlargement position based on an operation by a user.

6. The display control apparatus according to claim 3,
wherein the registration unit is configured to be capable of registering a condition in which an enlargement magnification of an image used at the last time in the enlargement mode is used as an enlargement magnification at a time of displaying an image in enlargement display according to an instruction to start the enlargement mode,
wherein the display control unit is configured, when the condition in which an enlargement magnification used at the last time in the enlargement mode is used is registered, to perform control to store the enlargement magnification immediately before ending the enlargement mode at a time of ending the enlargement mode.

7. The display control apparatus according to claim 3,
wherein the registration unit is further configured to be capable of registering an enlargement position at a time of displaying an image in the enlargement display according to an instruction to start the enlargement mode, and
wherein the display control unit is configured, in the case that the display control unit receives an instruction to start the enlargement mode, to perform control to enlarge and display an image in a display area based on an enlargement magnification and an enlargement position registered by the registration unit.

8. The display control apparatus according to claim 1, wherein the display control apparatus is configured, when the display control apparatus displays an image in the enlargement display according to an instruction to start the enlargement mode, to be capable of receiving, from an user, an instruction to perform at least one processing of deletion, addition of attributes, retouch, reproduction reservation, trimming, resizing, and image rotation to the image displayed in the enlargement display.

9. The display control apparatus according to claim 1,
wherein the display control apparatus is configured to be an image pickup apparatus including an imaging unit.

10. A display control apparatus substantially as hereinbefore described and shown in the accompanying drawings.

11. A control method of a display control apparatus comprising:
performing control to perform single display displaying an entirety of one image in a display area of a display unit,
performing control to perform multi display displaying a plurality of images in the display area,
receiving an instruction to start an enlargement mode,
performing control, in the case that the instruction to start the enlargement mode is received while the display control apparatus is in a state displaying an entirety of an image by the single display, to display a part of the enlarged image in the display area, and
performing control, in the case that the instruction to start the enlargement mode is received while the display control apparatus is in a state of displaying images by the multi display, to display in the display area a part of the image enlarged more than a single display of the image without going through display of the image in the single display mode.

12. A non-transitory medium readable by a computer storing a program which, when executed by the computer, causes the computer to operate as the display control apparatus according to claim 1.
